(19) United States
(12) Patent Application Publication
(10) Pub. No.: US 2023/0182610 A1
(43) Pub. Date: Jun. 15, 2023

(54) SYSTEM AND METHOD FOR CHARGING ELECTRIC VEHICLE INCLUDING BATTERY

(71) Applicant: OMRON Corporation, Kyoto (JP)

(72) Inventors: Katsumi MATSUSHITA, Kyoto (JP); Hiroyuki MINO, Kyoto (JP); Atsushi NOMURA, Kyoto (JP); Ryoji OKAZAKI, Kyoto (JP); Kenichi TABATA, Kyoto (JP); Daiki ANDO, Kyoto (JP)

(21) Appl. No.: 17/990,740

(22) Filed: Nov. 21, 2022

(30) Foreign Application Priority Data
Dec. 13, 2021 (JP) 2021-201895

(51) Int. Cl. B60L 53/66; H02J 50/12; H02J 7/00; B60L 53/12

(52) U.S. Cl. CPC B60L 53/665; H02J 50/12; H02J 7/00712; B60L 53/12

(57) ABSTRACT

A system for charging an electric vehicle including a battery includes a management computer and a charging station. The management computer stores multiple charging profiles for different battery types. The charging station includes a power transmission device and a charging controller. The power transmission device supplies electric power to the electric vehicle. The charging controller controls charging of the battery with the electric power from the power transmission device. The charging controller stores identification information about the battery. The charging controller transmits the identification information to the management computer. The charging controller acquires the charging profile corresponding to the identification information from the management computer. The charging controller controls charging of the battery according to the charging profile.

### CROSS-REFERENCE TO RELATED APPLICATION

This application claims priority to Japanese Patent Application No. 2021-201895, filed Dec. 13, 2021. The contents of that application are incorporated by reference herein in their entirety.

### FIELD

The present invention relates to a system and a method for charging an electric vehicle including a battery.

### BACKGROUND

Shared mobility services that rent out electric vehicles to users are becoming popular. For example, shared mobility services for electric vehicles such as electrically assisted bicycles or electric scooters are provided in some cities. In such services, charging stations for charging electric vehicles are arranged in various places in the city, and the electric vehicles are charged at the charging stations (see, for example, International Publication WO2019/188115).

### SUMMARY

In recent years, the aforementioned shared mobility services for electric vehicles have come to be provided by various management companies. Each management company has its own charging station. Therefore, the user moves to the charging station specified by the management company of the service to be used and charges the electric vehicle. Therefore, if the specified charging station is not nearby, the user has to travel far away, which is inconvenient.

On the other hand, it is not easy to provide a charging station that can commonly charge the electric vehicles of multiple management companies. This is because there are various types of electric vehicles that management companies use in their own services, and the types of batteries for electric vehicles are also various. Different battery types require different charging profiles to properly charge the battery. Therefore, if batteries of various types of electric vehicles are charged with a common charging profile, it is difficult to efficiently charge the batteries.

An object of the present invention is to provide a system and a method for efficiently charging electric vehicles of a plurality of management companies at a common charging station.

A system according to one aspect of the present invention is a system for charging an electric vehicle including a battery. The system includes a management computer and a charging station. The management computer stores multiple charging profiles for different battery types. The charging station includes a power transmission device and a charging controller. The power transmission device supplies electric power to the electric vehicle. The charging controller controls charging of the battery with electric power from the power transmission device. The charging controller acquires identification information about the battery. The charging controller transmits the identification information to the management computer. The charging controller acquires a charging profile corresponding to the identification information from the management computer. The charging controller controls charging of the battery according to the charging profile.

In the system according to the present aspect, the charging controller acquires the charging profile corresponding to the battery type from the management computer using the identification information. Therefore, it is possible to acquire a charging profile suitable for the battery of the electric vehicle at a charging station that can commonly charge the electric vehicles of various management companies. Thereby, the charging controller can efficiently charge the battery.

The identification information may include an identifier of the battery. In this case, by identifying the type of battery with the identifier, the charging profile suitable for the battery is specified.

The identification information may include an identifier of the electric vehicle. In this case, by identifying the type of electric vehicle with the identifier, the charging profile suitable for the battery of the electric vehicle is specified.

The identification information may include an identifier of the management company that manages the electric vehicle. In this case, by identifying the management company that manages the electric vehicle by the identifier, the charging profile suitable for the battery of the electric vehicle managed by the management company is specified.

The charging profile may indicate target values of voltage and/or current for charging the battery. The charging controller may control the voltage and/or current for charging the battery according to the charging profile. In this case, the voltage and/or current control suitable for charging the battery is performed according to the charging profile.

The system may further include a power receiving device. The power receiving device may be mounted on the electric vehicle and wirelessly receive electric power from the power transmission device. The charging controller may control the voltage and/or current supplied from the power receiving device to the battery according to the charging profile. In this case, it is not necessary to equip the charging station with charging connectors corresponding to the electric vehicles of each management company. Therefore, it becomes easier to share the charging station.

A method according to another aspect of the present invention is a method of controlling a charging station to charge an electric vehicle including a battery at the charging station. The method includes: acquiring identification information about the battery; transmitting the identification information to a management computer storing a plurality of charging profiles corresponding to battery types; acquiring a charging profile corresponding to the identification information; and controlling charging of the battery according to the charging profile.

In the method according to the present aspect, the charging profile corresponding to the battery type is acquired from the management computer. Therefore, at a charging station that can commonly charge the electric vehicles of various management companies, the electric vehicles are charged with a charging profile suitable for their own batteries. As a result, the battery can be efficiently charged.

Charging the battery at the charging station may be done by wireless power transfer. In this case, it is not necessary to equip the charging station with charging connectors corresponding to the electric vehicles of each management company. Therefore, it becomes easier to share the charging station.

### BRIEF DESCRIPTION OF THE DRAWINGS

FIG. 1 is a block diagram showing a configuration of a system according to an embodiment.

FIG. 2 is a perspective view showing an example of a charging station and an electric vehicle.

FIG. 3 is a block diagram showing a configuration of the charging station and the electric vehicle.

FIG. 4 is a diagram showing an example of a charging sequence.

FIG. 5 is a table showing an example of multiple charging profiles stored by a management computer.

FIG. 6 is a diagram showing an electric vehicle and a charging station according to another embodiment.

### DETAILED DESCRIPTION

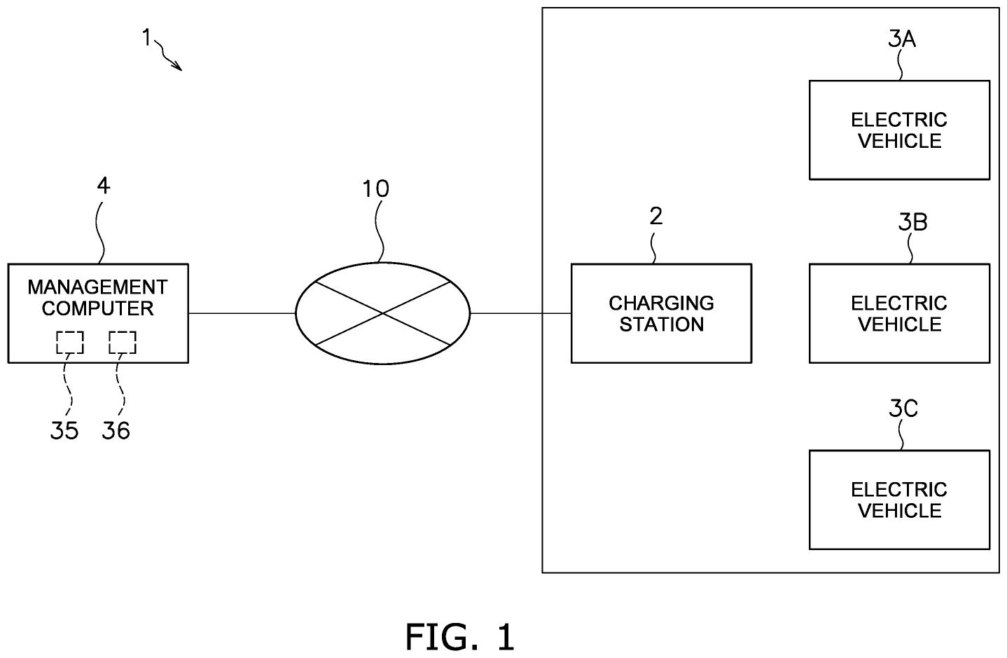

A system for charging an electric vehicle according to an embodiment will be described below with reference to the drawings. FIG. 1 is a block diagram showing a configuration of a system 1 according to an embodiment. The system 1 according to the embodiment is used in a shared mobility service that rents electric vehicles to users. In particular, the system 1 enables charging of various types of electric vehicles of multiple management companies that provide shared mobility services.

As shown in FIG. 1, system 1 includes a charging station 2, electric vehicles 3A to 3C, and a management computer 4. The charging station 2 supplies electric power to the electric vehicles 3A to 3C. The management computer 4 is connected to the charging station 2 via an information communication network 10 such as the Internet. The management computer 4 performs data communication with the charging station 2. Although only one charging station 2 is shown in FIG. 1, the management computer 4 performs data communication with a plurality of charging stations arranged at different locations.

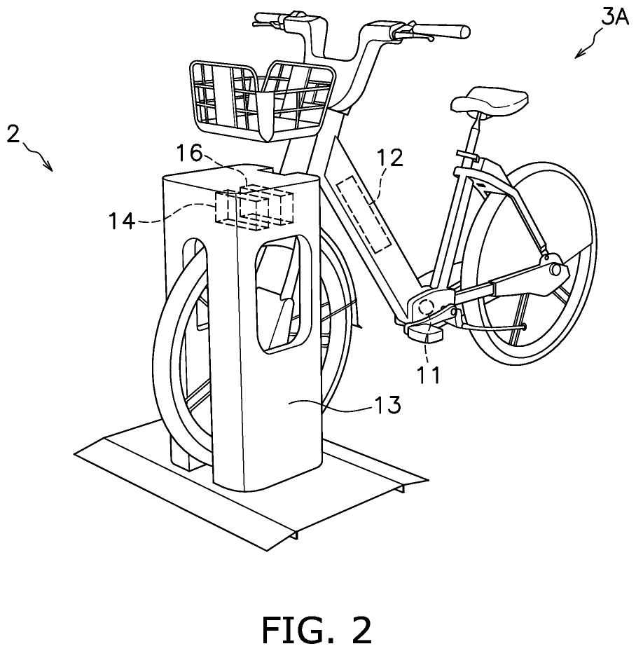

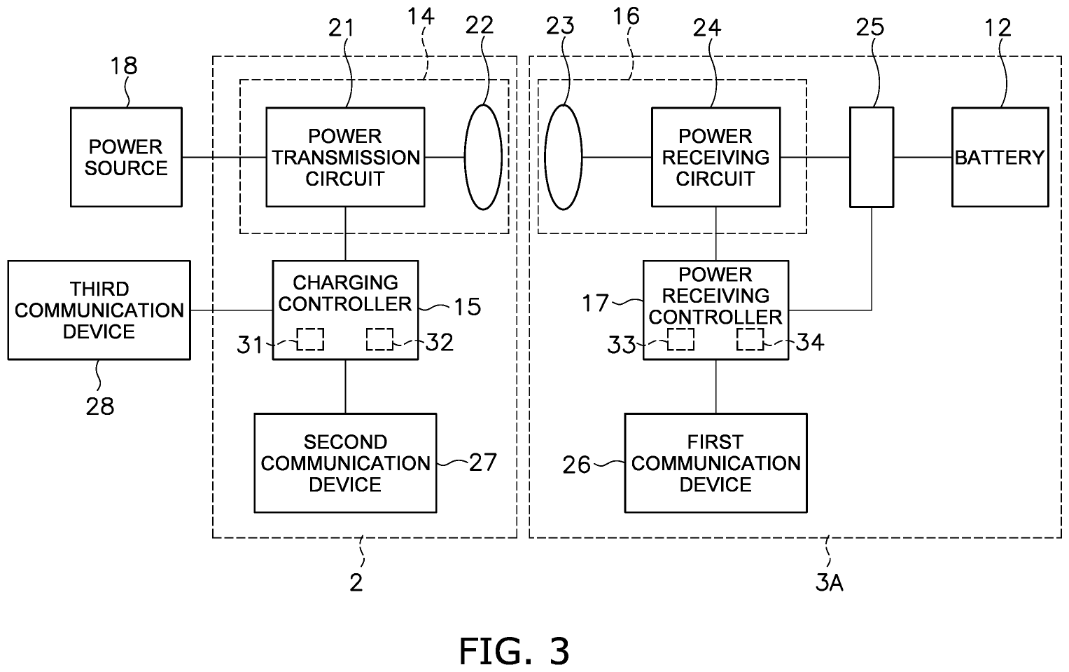

FIG. 2 is a perspective view showing an example of the charging station 2 and the electric vehicle 3A. FIG. 3 is a block diagram showing configurations of the charging station 2 and the electric vehicle 3A. In this embodiment, the electric vehicle 3A is an electrically assisted bicycle. Among the plurality of electric vehicles 3A to 3C, the electric vehicle 3A will be described below, but the other electric vehicles 3B and 3C also have the same configuration as the electric vehicle 3A. However, the plurality of electric vehicles 3A to 3C may be of different types.

As shown in FIG. 2, the electric vehicle 3A includes an electric motor 11 and a battery 12. The electric motor 11 is driven by electric power stored in the battery 12. The electric motor 11 generates driving force for assisting the running of the electric vehicle 3A. The battery 12 stores electric power for driving the electric motor 11.

The charging station 2 supplies electric power to the electric vehicle 3A for charging the battery 12 of the electric vehicle 3A. The charging station 2 includes a vehicle stand 13. The vehicle stand 13 holds the electric vehicle 3A. When the electric vehicle 3A is held on the vehicle stand 13, the charging station 2 automatically starts charging the electric vehicle 3A. Alternatively, the charging station 2 may include an input device such as a button or a touch screen, and start charging the electric vehicle 3A in accordance with the operation of the input device by the user.

As shown in FIG. 3, the charging station 2 includes a power transmission device 14 and a charging controller 15. The electric vehicle 3A includes a power receiving device 16 and a power receiving controller 17. The power transmission device 14 is connected to a power source 18 and supplies electric power to the power receiving device 16. The power transmission device 14 includes a power transmission circuit 21 and a power transmission coil 22. The power transmission circuit 21 controls electric power output to the power transmission coil 22. The power transmission circuit 21 includes, for example, a rectifier circuit and a resonance circuit. The power transmission coil 22 generates a magnetic field according to the electric power input from the power transmission circuit 21.

The power receiving device 16 includes a power receiving coil 23 and a power receiving circuit 24. The power receiving coil 23 generates an induced current according to the magnetic field generated by the power transmission coil 22. The power receiving circuit 24 controls electric power output from the power receiving coil 23 to the battery 12. The power receiving circuit 24 includes, for example, a rectifier circuit and a resonance circuit. The power receiving device 16 receives electric power from the power transmission device 14 by wireless power transfer. Electric power from the power transmission device 14 is transmitted to the battery 12 via the power receiving device 16.

The charging controller 15 controls the power transmission circuit 21 to control the electric power output from the power transmission circuit 21. Thereby, the charging controller 15 controls the voltage and current of the electric power supplied to battery 12. The charging controller 15 includes a storage device 31 and a processor 32 such as a CPU. The storage device 31 includes a memory. The storage device 31 may include an auxiliary storage device such as an HDD or an SSD. The storage device 31 stores programs and data for controlling electric power output from the power transmission device 14. The processor 32 executes processing for controlling electric power output from the power transmission device 14 according to programs and data.

The power receiving controller 17 controls the power receiving device 16 to control the electric power output from the power receiving device 16. The power receiving controller 17 includes a storage device 33 and a processor 34 such as a CPU. The storage device 33 includes a memory. The storage device 33 may include an auxiliary storage device such as an HDD or an SSD. The storage device 33 stores programs and data for controlling electric power output from the power receiving device 16. The processor 34 executes processing for controlling electric power output from the power receiving device 16 according to programs and data.

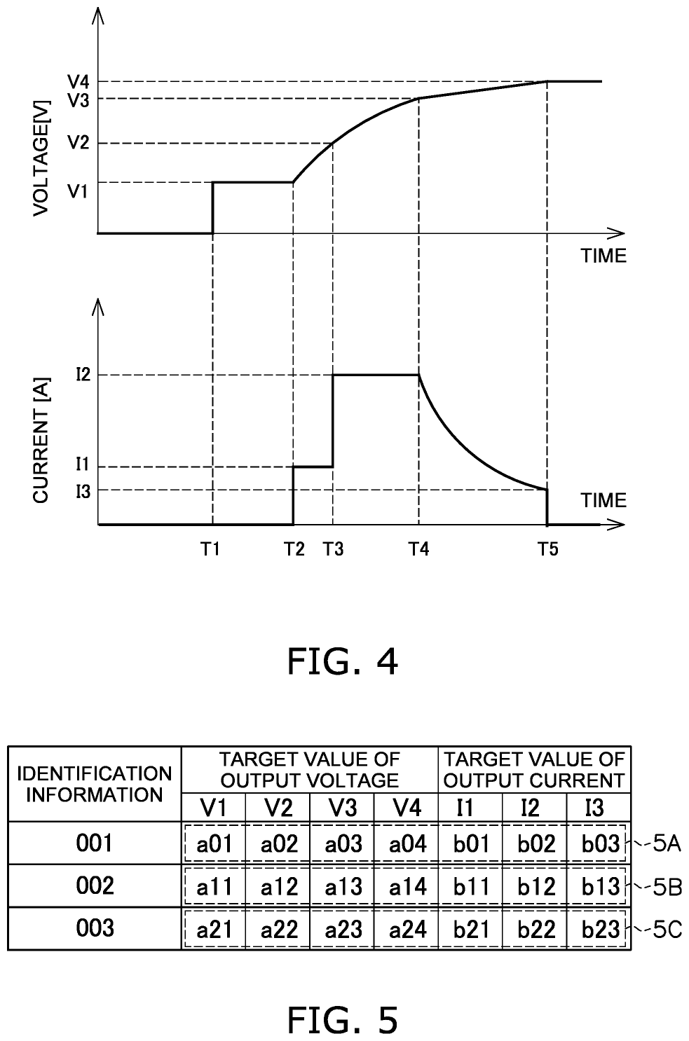

As shown in FIG. 3, the electric vehicle 3A includes a detection circuit 25. The detection circuit 25 detects the current (hereinafter referred to as “output current”) and voltage (hereinafter referred to as “output voltage”) of electric power output from the power receiving device 16. The charging controller 15 acquires the output current and the output voltage via the power receiving controller 17. The charging controller 15 charges the battery 12 by controlling the electric power output from the power transmission device 14 to the battery 12 according to the charging sequence shown in FIG. 4 while monitoring the output voltage and the output current.

As shown in FIG. 4, the charging controller 15 determines whether the output voltage is equal to or higher than a first voltage value V1 (time T1). If the output voltage is less than the first voltage value V1, the charging controller 15 does not initiate charging. When the output voltage is equal to or higher than the first voltage value V1, the charging controller 15 starts charging (time T2). The charging controller 15 maintains the output current at the first current value I1. As a result, the output voltage gradually rises (time T2−T3).

The charging controller 15 determines whether the output voltage is equal to or higher than a second voltage value V2. When the output voltage is less than the second voltage value V2, the charging controller 15 maintains the output current at the first current value I1. When the output voltage is equal to or higher than the second voltage value V2, the charging controller 15 increases the output current to the second current value I2 (time T3) and maintains the output current at the second current value I2. As a result, the output voltage gradually rises (time T3−T4).

The charging controller 15 determines whether the output voltage is equal to or higher than a third voltage value V3. If the output voltage is less than the third voltage value V3,the charging controller 15 maintains the output current at the second current value I2. When the output voltage is equal to or greater than the third voltage value V3, the charging controller 15 maintains the output voltage at a fourth voltage value V4. Note that the output voltage gradually rises to the fourth voltage value V4 with a delay from the command from the charging controller 15 to the power receiving circuit 24. As a result, the output current gradually decreases (time T4−T5).

The charging controller 15 determines whether the output current is equal to or less than a third current value 13. If the output current is greater than the third current value 13, the charging controller 15 maintains the output voltage at the fourth voltage value V4.If the output current is equal to or less than the third current value 13, the charging controller 15 terminates charging (time T5).

Suitable values of the first to fourth voltage values V1 to V4, which are the target values of the output voltage, and suitable values of the first to third current values I1 to 13, which are the target values of the output current, differ depending on the type of the battery 12. The charging controller 15 downloads a charging profile indicating these values from the management computer 4.

As shown in FIG. 3, the electric vehicle 3A includes a first communication device 26. The charging station 2 includes a second communication device 27 and a third communication device 28. The first communication device 26 and the second communication device 27 perform wireless communication with each other. For example, the first communication device 26 and the second communication device 27 each include a wireless communication module such as Bluetooth (registered trademark). The electric vehicle 3A and the charging station 2 perform data communication via the first communication device 26 and the second communication device 27.

The third communication device 28 is connected to the management computer 4 via the information communication network 10. The third communication device 28 is connected to the information communication network 10 via, for example, WiFi or a mobile communication network such as 3G, 4G, or 5G. Alternatively, the third communication device 28 may be connected to the information communication network 10 by wire. The charging station 2 performs data communication with the management computer 4 via the third communication device 28.

When the electric vehicle 3A is connected to the charging station 2, the charging controller 15 transmits to the management computer 4 a request command for downloading the charging profile.

The management computer 4 is located in a management center remote from charging station 2. The management computer 4 includes a storage device 35 and a processor 36 such as a CPU. The storage device 35 includes a memory. The storage device 35 may include an auxiliary storage device such as an HDD or an SSD. The storage device 35 stores programs and data for uploading a charging profile to the charging controller 15 in response to a request command. The processor 36 performs processing for uploading the charging profile according to the program and data.

The management computer 4 stores a plurality of charging profiles corresponding to the types of batteries 12. The charging profile is data indicating target values of voltage and current in charging the battery 12 described above. FIG. 5 is a table showing an example of a plurality of charging profiles 5A to 5C stored in management computer 4.

The management computer 4 stores charging profiles 5A to 5C in association with identification information. The identification information includes identifiers of multiple management companies that provide shared mobility services. For example, identifier 001 indicates Company A, which is a management company. Identifier 002 indicates Company B, which is the management company. Identifier 003 indicates Company C, which is the management company. Company A, Company B, and Company C are different companies.

Company A, Company B, and Company C provide shared mobility services using different electric vehicles. Different electric vehicles mean, for example, electric vehicles of different manufacturers. Alternatively, different electric vehicles may mean electric vehicles of different models even if they are made by the same manufacturer.

As shown in FIG. 5, the identifier 001 is associated with the first charging profile 5A. The first charging profile 5A includes target values a01-a04 of the output voltages V1-V4 and target values b01-b03 of the output currents I1-I3 suitable for charging the battery 12 of the electric vehicle 3A used by Company A.

The identifier 002 is associated with the second charging profile 5B. The second charging profile 5B includes target values a11-a14 of the output voltages V1-V4 and target values b11-b13 of the output currents I1-I3 suitable for charging the battery 12 of the electric vehicle 3B used by Company B. The identifier 003 is associated with the third charging profile 5C. The third charging profile 5C includes target values a21-a24 of the output voltages V1-V4 and target values b21-b23 of the output currents I1-I3 suitable for charging the battery 12 of the electric vehicle 3C used by Company C.

The charging controller 15 acquires identification information from the power receiving controller 17. The identification information includes an identifier that indicates the management company of the electric vehicle 3A. The charging controller 15 transmits a request command for the charging profile to the management computer 4 including the identification information. When the management computer 4 receives the request command from the charging controller 15, the management computer 4 acquires the identification information included in the request command. The management computer 4 transmits the charging profile corresponding to the identification information to the charging controller 15.

For example, when the management computer 4 receives the request command including the identifier of Company A, the management computer 4 transmits the first charging profile 5A corresponding to the electric vehicle 3A of Company A to the charging controller 15. When the management computer 4 receives the request command including the identifier of Company B, the management computer 4 transmits the second charging profile 5B corresponding to the electric vehicle 3B of Company B to the charging controller 15. When the management computer 4 receives the request command including the identifier of Company C, the management computer 4 transmits the third charging profile 5C corresponding to the electric vehicle 3C of Company C to the charging controller 15.

As described above, the charging controller 15 downloads the charging profile corresponding to the identification information from the management computer 4. The charging controller 15 controls the output voltage and output current to the battery 12 according to the charging profile.

In the system 1 according to the present embodiment described above, the charging controller 15 acquires from the management computer 4 a charging profile according to the battery of the electric vehicle used by each management company, using the identification information. Therefore, at the charging station 2 that can commonly charge the electric vehicles 3A to 3C of various management companies, the charging controller 15 acquires a charging profile suitable for the battery 12 of the electric vehicle connected to the charging station 2. Thereby, the charging controller 15 can efficiently charge the battery 12.

Although one embodiment of the present invention has been described above, the present invention is not limited to the above-described embodiment, and various modifications are possible without departing from the gist of the invention.

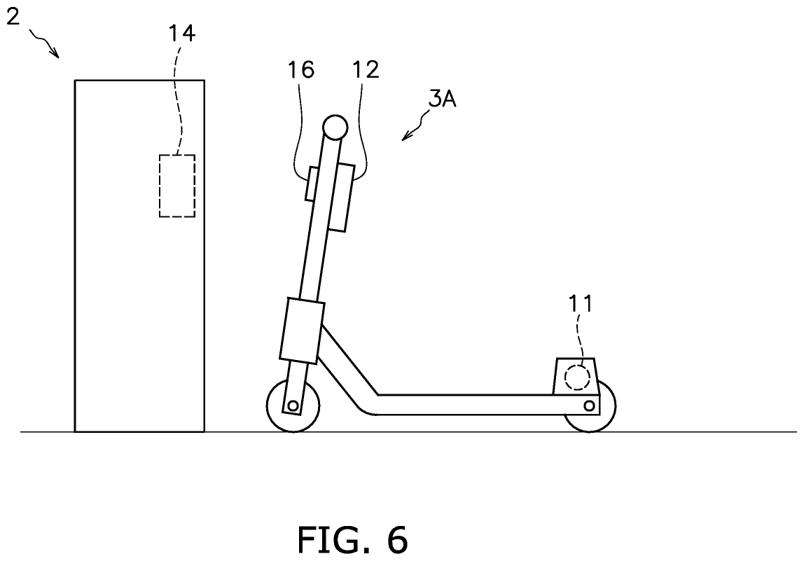

The electric vehicles 3A to 3C are not limited to electrically assisted bicycles, and may be other vehicles. For example, the electric vehicle 3A may be an electric scooter as shown in FIG. 6. In FIG. 6, the same reference numerals as in the above-described embodiment are assigned to the configuration of the electric scooter corresponding to the configuration of the electric vehicle 3A according to the above-described embodiment.

In the above embodiment, the identification information includes the identifier of the management company. However, the identification information may be related to the type of battery 12, and is not limited to the identifier of the management company. For example, identification information may include an identifier that indicates battery 12. The identifier indicating the battery 12 may indicate the type, model number, or product number of the battery 12, for example. The identification information may include an identifier that indicates the electric vehicle. The identifier indicating the electric vehicle may indicate the type, model number, or product number of the electric vehicle.

The power transmission device 14 and the power receiving device 16 may transmit power by wire. That is, the power transmission device 14 and the power receiving device 16 may be connected to each other by a cable. The power transmission device 14 may transmit electric power to the power receiving device 16 via the cable.

The charging sequence is not limited to that of the above embodiment, and may be changed. For example, the waveform of the output voltage in the charging sequence may be changed. The waveform of the output current in the charging sequence may be changed.

1. A system for charging an electric vehicle including a battery, the system comprising:
a management computer that stores a plurality of charging profiles corresponding to a type of the battery; and
a charging station including
a power transmission device that supplies electric power to the electric vehicle, and
a charging controller configured to control charging of the battery with the electric power from the power transmission device,
the charging controller being further configured to
acquire identification information about the battery,
transmit the identification information to the management computer,
acquire the charging profile corresponding to the identification information from the management computer, and
control charging of the battery according to the charging profile.

2. The system according to claim 1, wherein
the identification information includes an identifier of the battery.

3. The system according to claim 1, wherein
the identification information includes an identifier of the electric vehicle.

4. The system according to claim 1, wherein
the identification information includes an identifier of a management company that manages the electric vehicle.

5. The system according to claim 1, wherein
the charging profile indicates a target value of voltage and/or current for charging the battery, and
the charging controller is further configured to control the voltage and/or current for charging the battery according to the charging profile.

6. The system according to claim 1, further comprising
a power receiving device that wirelessly receives the electric power from the power transmission device, the power receiving device being mounted on the electric vehicle, wherein
the charging controller is further configured to control the voltage and/or current supplied from the power receiving device to the battery according to the charging profile.

7. A method of controlling a charging station to charge an electric vehicle including a battery at the charging station, the method comprising:
acquiring identification information about the battery;
transmitting the identification information to a management computer that stores a plurality of charging profiles according to a type of the battery;
acquiring the charging profile corresponding to the identification information from the management computer; and
controlling charging of the battery according to the charging profile.

8. The method according to claim 7, wherein
the identification information includes an identifier of the battery.

9. The method according to claim 7, wherein
the identification information includes an identifier of the electric vehicle.

10. The method according to claim 7, wherein
the identification information includes an identifier of a management company that manages the electric vehicle.

11. The method according to claim 7, wherein
the charging profile indicates a target value of voltage and/or current for charging the battery, the method further comprises
controlling the voltage and/or current for charging the battery according to the charging profile.

12. The method according to claim 7, wherein
the charging the battery at the charging station is performed by wireless power transfer.
